(19) United States
(12) Patent Application Publication
(10) Pub. No.: US 2005/0177655 A1
(43) Pub. Date: Aug. 11, 2005

(54) Method and apparatus for transporting data sections using a DMA controller

(75) Inventor: Werner Hein, Munchen (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Infineon Technologies AG

(21) Appl. No.: 11/055,385

(22) Filed: Feb. 10, 2005

(30) Foreign Application Priority Data
Feb. 11, 2004 (DE) 10 2004 006 767.8

(51) Int. Cl. G06F 13/28

(52) U.S. Cl. 710/22

(57) ABSTRACT

In a method for transporting (DMA_TASK(n), DMA_TASK(n+1)) data sections between a memory and a peripheral, a control signal (START(n+1)), which is used to ask a DMA controller (DMA) to transport (DMA_TASK(n+1)) a data section, is transmitted to the DMA controller, and information about the data transport operation (DMA_TASK(n+1)) to be carried out is then being loaded into the DMA controller, and the data is then being transported (DMA_TASK(n+1)) using the DMA controller.

### PRIORITY

This application claims priority from German Patent Application No. 10 2004 006 767.8, which was filed on Feb. 11, 2004.

### TECHNICAL FIELD OF THE INVENTION

The invention relates to a method and an apparatus which are used to transport data sections between a memory and a peripheral with the aid of a DMA controller.

### DESCRIPTION OF PRIOR ART

So-called SOC (System on Chip) designs are being used more and more often in the field of hardware development for mobile radio. SOC designs are complex, heterogeneous systems comprising a hardware platform, which, for example, has processors, buses, memories and peripherals, and software modules, for example device drivers, firmware, operating systems and applications. Peripherals are understood as meaning hardware devices, for example receivers, transmitters, channel coders and channel decoders. Peripherals furthermore also include hardware accelerator devices which handle low-complexity operations. In SOC designs, DMA (Direct Memory Access) control devices, in particular, are used to transport data sections between peripherals and a central rewriteable RAM (Random Access Memory), thus reducing the load on the central processor.

DMA control devices are generally referred to as DMA controllers in German specialist literature. For this reason, this term is also used below.

The load on the central processor is reduced further by virtue of the fact that configuration data is loaded into the DMA controller from the RAM or a peripheral after transportation of a data section has been concluded. The configuration data contains details of the data section to be transported next. The configuration data contains, for example, the start and destination addresses for the data to be transported as well as details of the amount of data in the data section to be transported. The DMA controller can use the configuration data to configure itself for its next task to be carried out, even before the latter. As soon as the DMA controller has configured itself, the peripheral can start the new data transport operation after an arbitrary period of time.

In conventional DMA controllers, the reconfiguration step is provided immediately after transportation of a data section has been concluded. However, in SOC designs having complex peripherals, the configuration data is not yet always available at this point in time. In particular, information about the amount of data to be transported may be lacking if, at this point in time, the peripheral in question has not yet finished generating the data section to be transported. In such cases, it is not possible to carry out self-configuration in a conventional DMA controller. Instead, the peripheral in question informs the central processor of the configuration data as soon as generation of the data has been concluded and the configuration data is available. The central processor then fetches the configuration data and uses it to configure the DMA controller for the next data transport task. The central processor then informs the peripheral in question that the DMA controller is now ready to operate. Only then can the actual data transport operation be started. Consequently, the disadvantage of the method described is that it increases the workload on the central processor and delays the data transport operation.

### SUMMARY OF THE INVENTION

The object of the invention, therefore, is to specify a method for transporting data sections between a memory and a peripheral, which, in comparison to conventional methods, reduces the load on the central processor and shortens the effective data transport time. A further aim is to provide an apparatus which serves the same purpose as the method and has the advantages mentioned.

The object on which the invention is based can be achieved by a method for transporting data sections between a memory and at least one peripheral, comprising the following steps which are to be carried out in the order specified:
(a) transmitting a control signal, which is used to ask a DMA controller to transport a data section, to the DMA controller;
(b) loading information about the data transport operation to be carried out into the DMA controller; and
(c) transporting the data using the DMA controller.

The DMA controller may use the information about the data transport operation to be carried out to perform self-configuration. The information about the data transport operation to be carried out may contain start and destination addresses for the data to be transported and, in particular, an indication of the amount of data in the data section to be transported. The information about the data transport operation to be carried out may contain an indication of the peripheral from which or to which a data section is transported after the data transport operation to be carried out presently has been concluded. The control signal, which is used to ask the DMA controller to transport the data, can be generated by the peripheral involved in transporting the data. The peripheral may transmit the control signal, which is used to ask the DMA controller to transport the data, to the DMA controller after the preceding data transport operation has been concluded.

The object can furthermore be achieved by an apparatus for transporting data sections between a memory and at least one peripheral, comprising a DMA controller for transporting data sections, means for generating a control signal which is used to ask the DMA controller to transport a data section, and means for generating information about the data transport operation to be carried out, which information is loaded into the DMA controller after the control signal has been fed to the DMA controller.

The DMA controller may have means for configuring the DMA controller using the information about the data transport operation to be carried out. The information about the data transport operation to be carried out may contain start and destination addresses for the data to be transported and, in particular, an indication of the amount of data in the data section to be transported. The information about the data transport operation to be carried out may also contain an indication of the peripheral from which or to which a data section is transported after the data transport operation to be carried out presently has been concluded. The peripheral which is involved in transporting the data may comprise the means for generating the control signal. The peripheral may transmit the control signal to the DMA controller after the preceding data transport operation has been concluded.

The method according to the invention is used to transport data sections between a memory and at least one peripheral. In a first method step, a control signal is fed to a DMA controller. The control signal is used to indicate to the DMA controller that transportation of a data section should be started. Immediately before transportation of the data section starts, information about the data transport operation to be carried out is loaded into the DMA controller in a second method step. In a third method step, the data is transported using the DMA controller.

The advantage of the method according to the invention is that the process of loading the information about the data transport operation to be carried out is decoupled, in terms of time, from the end of the last data transport operation carried out. Specifically, the information about the data transport operation to be carried out is loaded into the DMA controller only when it is definite that transportation of the data section can be started. At this point in time, the details needed by the DMA controller in order to transport the data are definitely available. No delays on account of unavailable details, for example of the amount of data to be transported, can therefore occur. As a result, in comparison to conventional methods, the central processor is exonerated from tasks which would possibly be due to be dealt with if the details needed were not available. The data is therefore transported according to the invention without the central processor interacting.

The DMA controller preferably uses the information about the data transport operation (to be carried out) itself to configure itself. This self-configuration of the DMA controller is now no longer bound—as in conventional DMA controllers—to the end of transportation of a data section but is carried out immediately before a data section is transported. This ensures that all data needed to configure the DMA controller is available during configuration.

The information about the data transport operation to be carried out preferably contains details of the addresses which the data to be transported has in the memory or the at least one peripheral from which said data is to be taken, and details of the addresses which the data has in the memory or the at least one peripheral to which said data is to be moved. In particular, the information about the data transport operation to be carried out also contains details of the amount of data in the data section to be transported.

It is furthermore advantageous if the information about the data transport operation to be carried out contains an indication of the peripheral from which or to which a data section is to be transferred after the data transport operation to be carried out presently has been concluded. This indication makes it possible for the DMA controller to reference the specified peripheral as the source of the next data transport operation after transportation of a data section has been concluded.

Since the peripheral involved in the data transport operation to be carried out knows the point in time at which both the data section to be transported and the information about transportation of this data section will be available, it is advantageous for the control signal which is used to ask the DMA controller to transport the data to be generated by said peripheral and transmitted to the DMA controller.

In accordance with one preferred refinement of the invention, the peripheral transmits the control signal which is used to ask the DMA controller to transport the data to the DMA controller after the data transport operation previously carried out by the DMA controller has been concluded. This preferred refinement of the invention prevents the tasks to be carried out from clashing in the DMA controller.

The apparatus according to the invention is used to transport data sections between a memory and at least one peripheral. In order to transport the data in this manner, the apparatus according to the invention has a DMA controller and two means. The first means is used to generate a control signal which is used to ask the DMA controller to transport a data section. The second means generates information about the data transport operation to be carried out, which information is loaded into the DMA controller after the latter has received the control signal.

The apparatus according to the invention has the same advantages over conventional apparatuses (which serve the same purpose) as the method according to the invention.

### BRIEF DESCRIPTION OF THE DRAWINGS

The invention is explained in more detail below, by way of example, with reference to the drawings, in which:

FIG. 1 shows an exemplary illustration of the timing of the transportation of data sections in accordance with the prior art;

FIG. 2 shows a schematic illustration of one exemplary embodiment of the apparatus according to the invention; and

FIG. 3 shows a schematic illustration of one exemplary embodiment of the method according to the invention.

### DESCRIPTION OF PREFERRED EMBODIMENTS

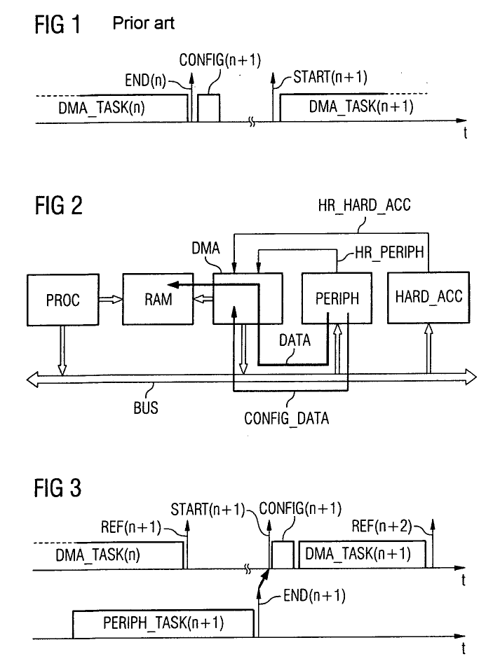

FIG. 1 shows, plotted against time t, the sequence for transporting data sections between a peripheral and a memory, as is effected using conventional methods.

Immediately after the DMA controller carrying out the data transport operation has concluded a data transport task DMA_TASK(n), that is to say immediately after a data section has been transmitted in full between the peripheral and the memory, which is indicated by a signal END(n), the DMA controller independently carries out a configuration operation CONFIG(n+1) for the next data transport task DMA_TASK(n+1), for which it loads configuration data from the peripheral. After configuration CONFIG(n+1) of the DMA controller has been concluded, an arbitrary period of time may pass before the peripheral sends a signal START(n+1) to the DMA controller in order to start the data transport task DMA_TASK(n+1). The data transport task DMA_TASK(n+1) is then carried out by the DMA controller.

In the case of the conventional method described above, the above-described complications may occur if the configuration data needed to configure CONFIG(n+1) the DMA controller is not available immediately after the data transport task DMA_TASK(n) has been concluded. This disadvantage is eliminated by the present invention.

FIG. 2 shows one exemplary embodiment of the apparatus according to the invention. The apparatus shown there comprises a central processor PROC, a rewriteable memory RAM, a DMA controller DMA, a peripheral PERIPH, a hardware accelerator device HARD_ACC and a data bus BUS. The central processor PROC can access both the memory RAM directly, and the peripheral PERIPH and the hardware accelerator device HARD_ACC via the data bus BUS. The DMA controller DMA is connected to the memory RAM and has access to the peripheral PERIPH and the hardware accelerator device HARD_ACC via the data bus BUS. Data or data sections can thus be transferred between the memory RAM and the peripheral PERIPH and the hardware accelerator device HARD_ACC, respectively, via the DMA controller DMA. The DMA controller DMA and the peripheral PERIPH and the hardware accelerator device HARD_ACC, respectively, are furthermore connected via so-called hardware request lines HR_PERIPH and HR_HARD_ACC. The function of the hardware request lines HR_PERIPH and HR_HARD_ACC is explained further below.

FIG. 3 shows one exemplary embodiment of the method according to the invention. The method of operation of the apparatus shown in FIG. 2 can furthermore be explained using FIG. 3.

The operation of processing the tasks imposed on the DMA controller DMA and the signals which are received or generated by the DMA controller DMA are plotted against time t in the top row of FIG. 3. The same applies analogously to the bottom row of FIG. 3, with the difference that this row relates to the peripheral PERIPH.

A data transport task DMA_TASK(n) imposed on the DMA controller DMA is processed by the DMA controller DMA moving a data section between the memory RAM and the peripheral PERIPH or the hardware accelerator device HARD_ACC. Partly at the same time as the data transport task DMA_TASK(n) is being processed, the peripheral PERIPH generates a new data section which is to be moved to the memory RAM later. This data section is generated within a data generation task PERIPH_TASK(n+1). The end of the data generation task PERIPH_TASK(n+1) is signalled by the signal END(n+1).

After the data transport task DMA_TASK(n) has been concluded, the DMA controller DMA carries out a referencing operation REF(n+1) in which it references the peripheral PERIPH as the source of the next data transport task DMA_TASK(n+1). However, as can be seen from FIG. 3, the data for the data transport task DMA_TASK(n+1) is not yet available at this point in time. As soon as the peripheral PERIPH has concluded its data generation task PERIPH_TASK(n+1), and thus both the data section intended for the next data transport operation and the data needed to configure the DMA controller DMA are available, the peripheral PERIPH transmits a signal START(n+1) to the DMA controller DMA via the hardware request line HR_PERIPH. If said data had been generated by the hardware acceleration device HARD_ACC, the signal START(n+1) would have been transmitted via the hardware request line HR_HARD_ACC.

The signal START(n+1) indicates to the DMA controller DMA that the data needed for the data transport task DMA_TASK(n+1) is now available and that the data transport operation should be started. However, before the data is actually transported, the DMA controller DMA follows its reference REF(n+1) and loads the configuration data from the peripheral PERIPH in order to use this configuration data to configure itself for the data transport task DMA_TASK(n+1). To this end, the configuration data typically comprises the start and destination addresses for the data to be transported as well as an indication of the amount of data in the data section to be transported. An arrow CONFIG_DATA in FIG. 2 shows the DMA controller DMA accessing the peripheral PERIPH which is used to load the configuration data into the DMA controller DMA.

After the configuration operation CONFIG(n+1) has been concluded, the DMA controller carries out the data transport task DMA_TASK(n+1) in which the previously generated data section is transferred from the peripheral PERIPH to the memory RAM. This is shown by an arrow DATA in FIG. 2.

Immediately after the data transport task DMA_TASK(n+1), the DMA controller DMA carries out a referencing operation REF(n+2) in which it references the source of the next data transport task DMA_TASK(n+2). The reference REF(n+2) may be understood quite generally as being a pointer which refers to a specific data source from which the signal START(n+2) is to be expected after an arbitrary period of time. The information about which peripheral or memory is this source is already contained in the configuration data which the DMA controller DMA used to configure itself before carrying out the data transport task DMA_TASK(n+1).

The transportation of a data section which was generated by the peripheral PERIPH has been described above. Such data sections may also be generated by other peripherals. Peripherals such as these also include the hardware accelerator device HARD_ACC. Furthermore, data sections may also be transported from the memory RAM to the peripherals.

1. A method for transporting data sections between a memory and at least one peripheral, comprising the following steps which are to be carried out in the order specified:
(a) transmitting a control signal, which is used to ask a DMA controller to transport a data section, to the DMA controller;
(b) loading information about the data transport operation to be carried out into the DMA controller; and
(c) transporting the data using the DMA controller.

2. The method according to claim 1, wherein
the DMA controller uses the information about the data transport operation to be carried out to perform self-configuration.

3. The method according to claim 1, wherein
the information about the data transport operation to be carried out contains start and destination addresses for the data to be transported and, in particular, an indication of the amount of data in the data section to be transported.

4. The method according to claim 1, wherein
the information about the data transport operation to be carried out contains an indication of the peripheral from which or to which a data section is transported after the data transport operation to be carried out presently has been concluded.

5. The method according to claim 1, wherein
the control signal, which is used to ask the DMA controller to transport the data, is generated by the peripheral involved in transporting the data.

6. The method according to claim 5, wherein
the peripheral transmits the control signal, which is used to ask the DMA controller to transport the data, to the DMA controller after the preceding data transport operation has been concluded.

7. An apparatus for transporting data sections between a memory and at least one peripheral, comprising
a DMA controller for transporting data sections,
means for generating a control signal which is used to ask the DMA controller to transport a data section, and
means for generating information about the data transport operation to be carried out, which information is loaded into the DMA controller after the control signal has been fed to the DMA controller.

8. The apparatus according to claim 7, wherein
the DMA controller has means for configuring the DMA controller using the information about the data transport operation to be carried out.

9. The apparatus according to claim 7, wherein
the information about the data transport operation to be carried out contains start and destination addresses for the data to be transported and, in particular, an indication of the amount of data in the data section to be transported.

10. The apparatus according to claim 7, wherein
the information about the data transport operation to be carried out contains an indication of the peripheral from which or to which a data section is transported after the data transport operation to be carried out presently has been concluded.

11. The apparatus according to claim 7, wherein
the peripheral which is involved in transporting the data comprises the means for generating the control signal.

12. The apparatus according to claim 11, wherein
the peripheral transmits the control signal to the DMA controller after the preceding data transport operation has been concluded.

13. A method for transporting data sections between a memory and at least one peripheral, comprising the following steps which are to be carried out in the order specified:
(a) transmitting a control signal, which is used to ask a DMA controller to transport a data section, to the DMA controller, wherein the control signal is generated by the at least one peripheral involved in transporting the data and wherein the peripheral transmits the control signal to the DMA controller after a preceding data transport operation has been concluded,
(b) loading information about the data transport operation to be carried out into the DMA controller; and
(c) transporting the data using the DMA controller.

14. The method according to claim 13, wherein
the DMA controller uses the information about the data transport operation to be carried out to perform self-configuration.

15. The method according to claim 13, wherein
the information about the data transport operation to be carried out contains start and destination addresses for the data to be transported and, in particular, an indication of the amount of data in the data section to be transported.

16. The method according to claim 13, wherein
the information about the data transport operation to be carried out contains an indication of the peripheral from which or to which a data section is transported after the data transport operation to be carried out presently has been concluded.
